(19) United States
(12) Patent Application Publication
(10) Pub. No.: US 2015/0178449 A1
(43) Pub. Date: Jun. 25, 2015

(54) Methods and Systems For Automated Personal Health Information Retrieval and Release

(71) Applicant: Diane Elizabeth Ferry, Wilmington, DE (US)

(72) Inventor: Diane Elizabeth Ferry, Wilmington, DE (US)

(21) Appl. No.: 14/577,318

(22) Filed: Dec. 19, 2014

Related U.S. Application Data
(60) Provisional application No. 61/964,156, filed on Dec. 24, 2013.

(51) Int. Cl. G06F 19/00

(52) U.S. Cl. CPC G06F 19/322

(57) ABSTRACT

Methods and systems related to automating the retrieval and release of patient health care records are disclosed to make the process more accessible, more accurate, more timely, and more secure. The methods comprise enabling a requestor to transmit over a network a health care records request, proof of identity, and a designated destination to a system manager for review. The methods also comprise enabling the system manager to ensure that the requestor is authorized to obtain or release the requested records, access the requested records electronically, and send the requested records to the designated destination. The methods may also allow for automated payment of the fees associated with the records request. Systems employing the methods over one or more computer networks are also disclosed.

### CROSS REFERENCE TO RELATED APPLICATIONS

This application claims priority to U.S. Provisional Application Ser. No. 61/964,156, filed Dec. 24, 2013, which is incorporated herein by reference in its entirety.

### FIELD

The present disclosure relates generally to methods and systems for automated personal health information retrieval and release and particularly to methods and systems for a patient or an authorized representative of that patient to obtain and/or release copies of patient health information, including protected health information.

### BACKGROUND

As an individual patient receives health care services at a hospital or receives health care services from an individual health care professional, such as a primary care physician, specialty care physician, or other health care professional, various staff members of the hospital or physician's office, including physicians, nurses, therapists, technicians, and others who create records of the health care services performed for that patient. The personal health care records or personal health information may include narrative reports such as examination reports, medication reports, consultation reports, diagnoses, etc., and may include technology-created/supported images and reports from medical imaging modalities, laboratories, physiological testing modalities, and other invasive and non-invasive ancillary services. The health care professional may create personal health records for a patient by means of handwritten entries or computer entries. In other cases, some or all of the personal health care records for a patient may be the product of a diagnostic or therapeutic piece of equipment. These records are then stored or maintained by the health care professional or under the direction of the health care professional for later retrieval.

Often a patient, or representative of the patient, may need to obtain copies of some or all of the personal health care records or authorize the release of these copies to a third party. The individual requesting the retrieval or release of the personal health information may need to do so for a variety of reasons. For example, the patient may need to release his or her medical records to a new health care professional so that its staff members may be apprised of the current medical status of the patient to ensure proper care or treatment. In other cases, the medical records may need to be presented to a government agency for enrollment in a disability program, to a court to prove up medical bills and pain and suffering, or for some other purpose.

Importantly, the medical records, or personal health information, include certain patient identifying information, the type of health care service performed on the patient, and the date on which the health care service was performed, all of which constitute protected health information PHI) under the Health Insurance Portability and Accountability Act of 1996 HIPAA). Particularly, HIPAA controls the confidentiality and security of PHI as well as the processes for disclosure of PHI. In addition, the handling, storage, and release of certain patient health information may be regulated under other legislation such as the Health Information Technology for Economic and Clinical Health Act HITECH) or the Genetic Information Nondiscrimination Act GINA).

In order to obtain or release personal health information, a patient or authorized representative of the patient, typically enters the professional health care facility where the health care services were performed and inquires in the reception area how to obtain or release copies of the patient's medical records. The reception personnel must then determine the location of the appropriate record storage area and relay this information to the requestor, who must then travel to the record storage area in that facility or, in some cases, must travel to a record storage area in a separate facility. Once the requestor finds the appropriate storage area and locates the facility representative responsible for the release of the patient medical records, the requestor must then fill out a paper request form by hand. The representative reviews the form for legally-required elements and, if necessary, instructs the requestor to correct or complete the form or to clarify any illegible writing. The requestor must then present proof of identify and pay the fee associated with the request. Each of these steps costs the requestor time and causes inconvenience and frustration. In addition, if this process is not performed completely or correctly according to applicable legal requirements, the paper request form is returned to the requestor who must then correct or complete the request, thus increasing the turn-around time for obtaining or releasing the medical records.

At this time, the representative must then log the request, identification materials, fee, and payment into a records request tracking system, which is often a source of entry error or other clerical errors further delaying and inconveniencing the requestor. After the representative logs the request information into the system, he or she must then access the patient record and locate the requested personal health information. A copy of the requested personal health information is then created on the appropriate medium and sent to the patient or an authorized third-party. Often times, each of the above tasks are performed by different representatives at different locations, resulting in inefficiencies and longer turn-around times. Indeed, the current system for medical records and personal health information retrieval and release has been a problem for many years due to its inefficiency and poor service satisfaction for requestors.

What is needed is a method and system that greatly improves the process for patients and their authorized representatives to obtain copies of personal health care records in a secure, accurate, and timely manner.

### SUMMARY

It is an object of the present disclosure to provide a method performed by a computing device that includes a memory and one or more processors to obtain personal health information. The method includes a step a) comprising receiving a records request from a client device over a network, wherein the client device is operated by a requestor, and wherein the records request comprises requested personal health information, identifying information for a patient associated with said requested personal health information, identifying information for the requestor, and a designated destination for sending said requested personal health information. Furthermore, the method includes a step b) comprising presenting the records request to a system manager and enabling the system manager to determine whether the requestor is authorized to obtain said requested personal health information, access a first database comprising a plurality of patient data, wherein each of said patient data is associated with a storage medium comprising personal health information for a patient, and wherein said personal health information comprises said requested personal health information, and send said requested personal health information to said designated destination. Additionally, the method includes a step c) comprising creating a second database comprising a plurality of tracking data related to steps a) and b).

In certain embodiments, the records request further comprises a specified delivery medium for sending said requested personal health information to said designated destination, and wherein said system manager is further enabled to send said requested personal health information as said specified delivery medium.

In other embodiments, the method further comprises after step b) and before step c) the further steps of b) 1) sending to the requestor a payment requirement sufficient to pay for services and fees associated with said records request, and b) 2) notifying said system manager when said payment requirement has been paid, and wherein said second database further comprises a plurality of tracking data related to steps b) 1) and b) 2). In some implementations, the payment requirement is collected by a merchant processor.

In certain embodiments, the client device comprises a personal computer, workstation, laptop, computer tablet, personal digital assistant, kiosk, or wireless application protocol-enabled device. In other embodiments, the client device comprises a graphical user interface for displaying to the requestor a succession of self-directed screens configured to enable said requestor to enter said records request. In yet other embodiments, the client device further comprises a magnetic card reader configured to read magnetically imprinted cards.

In an embodiment, the storage medium is electronic. In another embodiment, the client device further comprises a digital image capture device comprising an image sensor having a plurality of sensor pixels for capturing a digital image and presenting said digital image to the system manager. In yet another embodiment, the client device further comprises an electronic device configured to collect a plurality of biometric data from said requestor.

In some embodiments, the requestor is the patient associated with said requested personal health information. Alternatively, the requestor is an authorized representative. In certain embodiments, the requestor is enabled to query said tracking data of said records request.

In certain embodiments, the personal health information is created by a health care provider. In other embodiments, the health care provider comprises a hospital, individual health care professional, physician, nurse, therapist, or technician.

In an embodiment, each of said personal health information, second database and network is maintained with at least industry standards and legal requirements for financial data and health records.

It is another object to provide a system comprising a processor and a memory for obtaining personal health information comprising: a) a client device configured to send a records request over a network, wherein said records request comprises requested personal health information, identifying information for a patient associated with said requested personal health information, identifying information for a requestor operating said client device, and a designated destination for sending said requested personal health information; b) a central unit configured to receive said records request and to provide to a system manager access to said records request, wherein said system manager is further enabled to determine whether said requestor is authorized to obtain said requested personal health information, access a patient database comprising a plurality of patient data, wherein each of said patient data is associated with a storage medium comprising personal health information for a patient, and wherein said personal health information comprises said requested personal health information, and send said requested personal health information to said designated destination; and c) a transaction database. Furthermore, the central unit is further configured to track and record actions of a) and b) for storage in said transaction database.

In one embodiment, the records request further comprises a specified delivery medium for sending said requested personal health information to said designated destination, and wherein said system manager is further enabled to send said requested personal health information as said specified delivery medium. In another embodiment, the system manager is further enabled to notify said requestor of a payment requirement sufficient to pay for services and fees associated with said records request, and wherein said central unit tracks and records said notification of a payment requirement for storage in said transaction database. In some embodiments, the system further comprises a payment module for automatically notifying the system manager when said payment requirement has been paid.

In certain embodiments, the client device comprises a personal computer, workstation, laptop, computer tablet, personal digital assistant, kiosk, or wireless application protocol-enabled device. In other embodiments, the client device comprises a graphical user interface for displaying to the requestor a succession of self-directed screens to enable the requestor to enter said records request. In yet other embodiments, the client device further comprises a magnetic card reader configured to read magnetically imprinted cards.

In one embodiment, the storage medium is electronic. In another embodiment, the client device further comprises a digital image capture device comprising an image sensor having a plurality of sensor pixels for capturing a digital image and presenting said digital image to the system manager. In other embodiments, the client device further comprises an electronic device configured to collect a plurality of biometric data from said requestor.

In one embodiment, the system further comprises a merchant processor capable of payment collection. In another embodiment, the requestor is enabled to access said transaction database. In yet another embodiment, each of said personal health information, network, central unit, and transaction database is maintained with at least industry standards and legal requirements for financial data and health records.

These and other objects can be achieved through the use of the automated patient engagement technology methods and systems that facilitate the timely, secure, accurate, and legally compliant retrieval or release of personal health information.

Other and further objects, features, and advantages will be readily apparent to those skilled in the art.

### BRIEF DESCRIPTION OF THE DRAWINGS

The foregoing summary, as well as the following detailed description of the illustrative embodiments, is better understood when read in conjunction with the appended drawings. For the purpose of illustrating the embodiments, there are shown in the drawings example constructions of the embodiments; however, the embodiments are not limited to the specific methods and instrumentalities disclosed. In the drawings:

FIG. 1 is a diagrammatical overview of one embodiment of the automated process of obtaining personal health information.

FIG. 2 is a flow chart depicting an embodiment of the automated process of obtaining personal health information.

FIGS. 3A-C is a flow chart depicting an embodiment of a self-directed instructional display.

FIG. 4 is a block diagram of an embodiment of a suitable computing environment for use in the automated process of obtaining health care records.

FIG. 5 is a block diagram of an embodiment of a kiosk suitable for use in the automated process of obtaining personal health information.

FIG. 6 is an exemplary front view of the kiosk of FIG. 5.

FIG. 7 is a block diagram of an embodiment of a system server suitable for use in the automated process of obtaining personal health information.

FIG. 8 is a exemplary embodiment of a fingerprint scanner suitable for use in the automated process of obtaining personal health information.

### DETAILED DESCRIPTION

### Definitions:

As used herein, the singular form of a word includes the plural, and vice versa, unless the context clearly dictates otherwise. Thus, the references “a”, “an”, and “the” are generally inclusive of the plurals of the respective terms. For example, reference to “a method” includes a plurality of such “methods”. Similarly, the words “comprise”, “comprises”, and “comprising” are to be interpreted inclusively rather than exclusively. Likewise, the terms “include”, “including”, and “or” should all be construed to be inclusive, unless such a construction is clearly prohibited from the context. Similarly, the term “examples”, particularly when followed by a listing of terms, is merely exemplary and illustrative and should not be deemed to be exclusive or comprehensive.

The term “comprising” is intended to include embodiments encompassed by the terms “consisting essentially of” and “consisting of”. Similarly, the term “consisting essentially of” is intended to include embodiments encompassed by the term “consisting of”.

Where used herein, ranges are provided in shorthand to avoid having to list and describe each and every value within the range. Any appropriate value within the range can be selected, where appropriate, as the upper value, lower value, or the terminus of the range.

The methods, systems, and other advances disclosed herein are not limited to particular methodology, protocols, and techniques described herein because, as the skilled artisan will appreciate, they may vary. Further, the terminology used herein is for the purpose of describing particular embodiments only, and is not intended to, and does not, limit the scope of that which is disclosed or claimed.

Unless defined otherwise, all technical and scientific terms, terms of art, and acronyms used herein have the meanings commonly understood by one of ordinary skill in the art in the field s) of the present systems and methods, or in the field s) where the term is used. Although any methods, systems, or other means or materials similar or equivalent to those described herein can be used in the practice of the present methods and systems, the preferred methods, systems, or other means or materials are described herein.

The term “access module” as used herein refers to a selection of electronic circuits within a central unit, system server, system server computer, or any other computing device configured to enable the central unit, system server, system server computer, or another computing device to communicate over one or more networks with one or more client devices and one or more external databases. The term “access module” is not intended to be limited to any particular arrangement of electronic circuits. The “access module” may communicate with one or more external computing devices on one or more computer networks including a local area network LAN), wide area network WAN), virtual network, and the like). In some embodiments, the “access module” communicates with an external device on the Internet via a secure portal or website.

The term “central unit”, sometimes used interchangeably with “system server” or “system server computer”, is used herein to refer to a computing device capable of accepting requests from a client and giving responses accordingly. The “central unit” or “system server” may run on any computing device including dedicated server computers.

The term “merchant processor” as used herein refers to the relationship with payment collection from requestors. The merchant processor role may be carried out by the system manager, or by a third party that specializes in merchant process, including credit card or debit purchasing, electronic funds transfer or collecting and/or processing other payment from the requestors.

The term “payment module” as used herein refers to a selection of electronic circuits within a central unit, system server, system server computer, or any other computing device configured to enable the central unit, system server, system server computer, or any other computing device to communicate over one or more networks with one or more merchant processors. The “payment module” may enable communication with one or more external computing devices on one or more computer networks including a LAN, WAN, virtual network, and the like) for the purpose communicating financial information such as credit/debit card information, bank account information, information regarding amount of fees that must be paid, payment of fees, and the like). In some embodiments, the “payment module” communicates with an external device on the Internet via a secure portal or website. In other embodiments, the “payment module” communicates with a non-public network maintained by a third party that specializes in the merchant process, including credit card or debit processing, electronic checks, electronic funds transfer, or collecting and/or processing other payment from requestors.

The term “personal health information”, sometimes used interchangeably with “patient health care records” or “medical records”, is used herein to refer to information relating to one or more professional health care services provided for a patient and/or that will be provided for a patient at a future time and may include information relating to a particular health care service provided, type of health care record, the date on which a particular health care service was performed, the identity and address of the health care provider performing the health care service, and/or identifying information for the patient associated with the personal health information.

The term “professional health care provider”, sometimes used interchangeably with the term “health care provider” or “health care professional”, is used herein to refer to a hospital, clinic, center, practice, facility, office, or mobile unit wherein a physician, physician's assistant, nurse, therapist, technician, primary care physician, specialty care physician, or other professional health care provider provides health care services to a patient. In addition, the term “professional health care provider” or “health care provider” or “health care professional” may refer herein to a physician, physician's assistant, nurse, therapist, technician, primary care physician, specialty care physician, or other professional health care provider that provides health care services to a patient.

The term “requested personal health information” as used herein refers to a request for a patient's health care records or medical records and may include one or more types of health care services provided for the patient, types of health care records, dates on which particular health care services were performed, the identity and address of the health care provider performing the health care service, and/or identifying information for the patient associated with the personal health information.

The term “requestor” as used herein refers to a person or an entity that uses the present methods and systems to make a request for personal health information. The “requestor” may be the patient associated with the requested personal health information or another person or entity that is authorized to obtain the requested personal health information.

The term “system manager”, sometimes used interchangeably with “system administrator”, refers to one or more persons or entities that manage one or more administrative aspects of the present methods and systems for obtaining health care information. The “system manager” may refer to one or more persons located on-site at the professional health care provider's facility or at an off-site location. The “system manager” may additionally refer to any employee, agent, or other individual under the direction of a manager or administrator of the present system for the purposes of managing one or more aspects of the present methods and systems for obtaining health care information.

The term “tracking module” as used herein may refer to a selection of electronic circuits within a central unit, system server, system server computer, or any other computer device configured to track and record the receipt, processing, and fulfillment of a health care records request. The term “tracking module” as used herein also may refer to a set of computer-executable instructions e g, a software program) configured to operate on a selection of electronic circuits within a central unit, system server, system server computer, or any other computing device to track and record the receipt, processing, and fulfillment of the requests for personal health care information. The “tracking module” contains data elements provided in the requests and processing steps performed using the present methods and systems. In some embodiments, the “tracking module” is configured to automatically track and record the receipt, processing, and fulfillment of a health records request.

All patents, patent applications, publications, technical and/or scholarly articles, and other references cited or referred to herein are in their entirety incorporated herein by reference to the extent allowed by law. The discussion of those references is intended merely to summarize the assertions made therein. No admission is made that any such patents, patent applications, publications, or references, or any portion thereof, are relevant, material, or prior art. The right to challenge the accuracy and pertinence of any assertion of such patents, patent applications, publications, and other references as relevant, material, or prior art is specifically reserved.

### Description:

The present disclosure solves the problem through a patient engagement technology system and process that assures the medical records requests are complete and meet all the legal requirements for obtaining copies of patient health information, thereby assuring HIPAA compliance, minimizing rejections of records requests, and greatly reducing inappropriate or illegal releases of medical records. The present disclosure enables a requestor to specify the exact types and dates of the desired personal health information, specify the manner and destination of the desired delivery, and present identity proof at a single enabled computer device, each of which are then automatically transmitted to a system administrator, or system manager, who may be at the health care facility or at a distant location. The system manager may then review the request, authorization, and proof of identity to ensure HIPAA compliance before electronically accessing the records and sending them to the specified delivery destination. In addition, the system includes information on the status of the request fulfillment that the requestor can query to obtain up-to-date and accurate transaction status.

Furthermore, the present system can be deployed on computing devices located in, e g, hospitals and office receptions areas, inpatient care units, emergency rooms, clinics, or ancillary treatment areas of hospitals or physician offices. In addition, the system can be utilized from any location via the Internet.

In its various aspects, the present disclosure features methods and systems for obtaining copies of health care records or personal health information. Generally, a patient is a person that receives health care services from any professional health care provider. Such health care services may include inpatient, outpatient, emergency services, sexually transmitted disease STD) screening, drug testing, psychological evaluation and/or testing, surgery, genetic screening/testing, or any other type of health care services known in the art. The health care services may be performed on the patient at a hospital, clinic, center, practice, facility, office, or mobile unit wherein a physician, physician's assistant, nurse, therapist, technician, primary care physician, specialty care physician, or other professional health care provider provides such health care services to a patient. As the professional health care provider performs health care services on a patient, that professional health care provider or an employee of the professional health care provider) may create a patient health care record associated with that patient.

As discussed herein, a patient health care record may include any information related to health care services performed on the patient and/or health care services that will be performed on the patient at a future time. Additionally, the type of information included in the patient health care record may include one or more examination reports, medication reports, consultation reports, orders, progress notes, prescriptions, diagnoses, prognoses, laboratory results and/or reports, physiological and psychological test results, STD and HIV/AIDS status, blood tests, genetic screening results and/or reports, mental health assessment, reports related to other invasive or non-invasive ancillary care services, and technology created/supported medical images such as a digital camera image, magnetic resonance image MRI), X-ray, computerized tomography CT) scan, electrocardiogram EKG), positron emission tomography PET) scan, ultrasound, and the like).

These patient health care records may be created by means of handwritten entries or computer entries by persons or automatically by diagnostic and/or therapeutic equipment. In any case, the patient health care records may be maintained in many different types of media and in either centralized or decentralized locations within the same hospital or health care provider facility where the professional health services were rendered or at a different hospital or health care provider facility. The patient health records may be stored in any storage medium commonly used in the art including, e g, electronic, paper-based, or a combination of both.

The professional health care provider may create and maintain a patient database that contains the patient health care records themselves if stored as an electronic storage medium or, if the patient health care records are in a paper medium, an electronic record that such patient health care records exist and where they can be found. In any case, the patient database may provide all or a portion of the patient health care records or other personal health information associated with a given patient. The patient health care records may be maintained, e g, in a single patient database housed on-site at the facility of the health care provider, in a single database maintained offsite at a third party location, or in multiple patient databases located either on-site at the facility of the health care provider or off-site at a third party location. In a preferred embodiment, the patient database and access thereto is maintained with at least industry standards and legal requirements for PHI.

In some embodiments, patient health care records may include patient identifying information, one or more types of health care services rendered, one or more types of health care records, and the dates on which the health care services were performed or will be performed, all of which constitute PHI as defined by HIPAA and other federal legislation and regulation. These laws and regulations control the confidentiality and security of PHI as well as the processes for disclosure of PHI. Thus, the federal law and regulations at any given time determine who is authorized to access and view certain patient health care records for a given patient and what documentation, if any, is required to establish such authorization.

In some embodiments, a requestor may desire to obtain one or more copies of some or all of the personal health information associated with a particular patient. The requestor may desire copies of such patient health care records for himself or herself or for a third party, such as an attorney, insurance company, state disability bureau, the Social Security Administration, future employer, another professional health care provider, or any other person, organization, or government agency of the requestor's choosing. In some embodiments, the requestor is the patient associated with the desired patient health care records. In other embodiments, the requestor is an authorized representative of the patient. In some embodiments, the requestor's status as an authorized representative is determined by then-existing federal law and regulations such as HIPAA, HITECH, and/or GINA). It is to be understood that the requestor's status as an authorized representative may be affected by amendments to the existing law or by newly enacted laws.

It is an object to provide a system wherein a requestor, such as a patient or an authorized representative of that patient, may request copies of personal health information or request the release of such copies to a designated third person by using a computing device enabled to communicate with the central unit or system server and present the records request to a system manager enabled to: 1) determine if the requested personal health information exists; 2) determine whether the requestor is authorized to obtain copies of the requested personal health information and/or release copies of the requested personal health information to a designated third person; 3) access the requested personal health information; and 4) send the requested personal health information to the designated destination. The following description provides nonlimiting examples of how such a system can perform the desired functions.

The present system is automated in a computing environment that includes one or more central units, or system server computers, enabled to communicate with one or more computing devices and/or databases over one or more computer networks. In some embodiments, the system manager is enabled to use the central unit itself as a computing system for receiving requests from the requestor and accessing one or more external patient databases in order to access the requested personal health information. In other embodiments, the system manager uses an enabled computing device such as a desktop personal computer PC), workstation, laptop, computer tablet, personal digital assistant PDA), any wireless application protocol WAP)-enabled device, or any other computing device) in communication with the central unit, which can be a dedicated system server, to receive requests from the requestor and access one or more external patient databases comprising the requested personal health information. The central units/system servers may be located or maintained at a centralized location offsite from one or more professional health care provider facilities. Alternatively, the central units/system servers are located within one or more professional health care facilities. In certain embodiments, at least a portion of the one or more computer networks is non-public or private. Non-public networks include password restricted networks, encrypted networks, paid networks, membership networks, and other networks not open to the general public. In addition, the databases disclosed herein are preferably kept private and maintained securely. The security can be based, for example, on industry standards and legal requirements for financial data and/or health records.

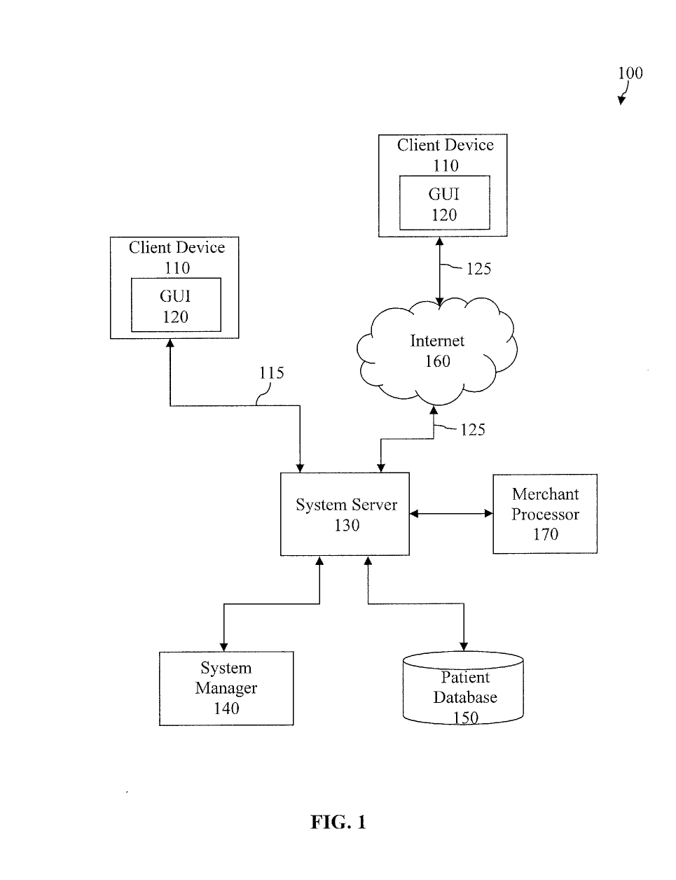

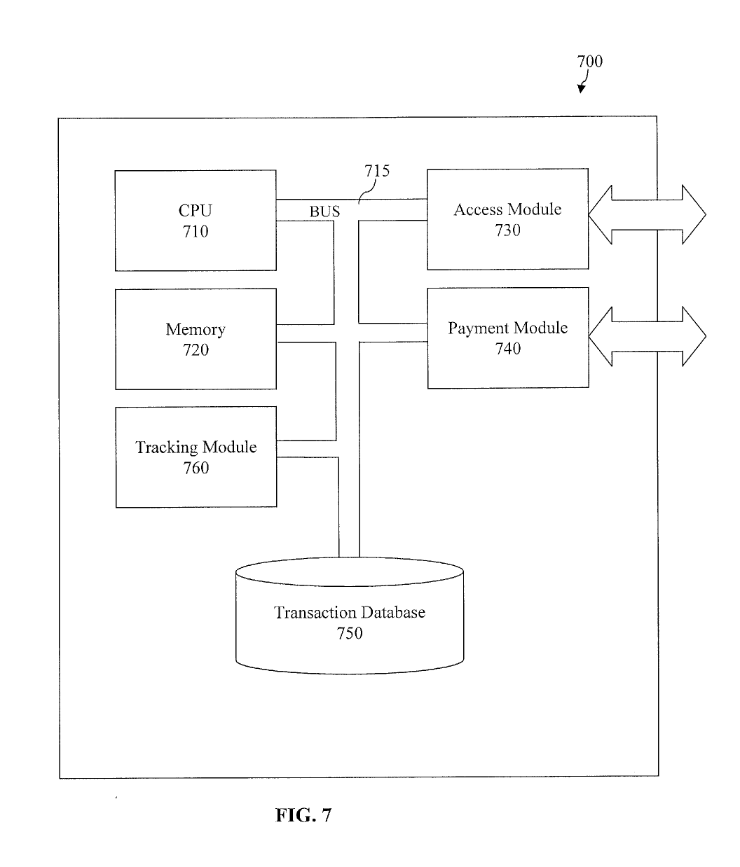

A central unit, such as system server 130 depicted in FIG. 1 or system server 700 depicted in FIG. 7, will enable a requestor to send a health care records request over a network to a system manager 140 who can quickly review that request to ensure compliance with, e g, legal requirements. In particular, the requestor enters the health care records request using any computing device, such as client device 110, capable of interfacing either directly or indirectly with the network. Client device 110 may be a desktop PC, workstation, laptop, computer tablet, PDA, kiosk, or any WAP device, or any other computing device capable of interfacing directly or indirectly with the network. The records request is sent from the client device 110 and delivered to the system server 130 and presented to the system manager 140, who is enabled to determine whether the requestor is authorized to obtain or release the requested personal health information as well as to access a patient database 150 and obtain the requested personal health information contained therein.

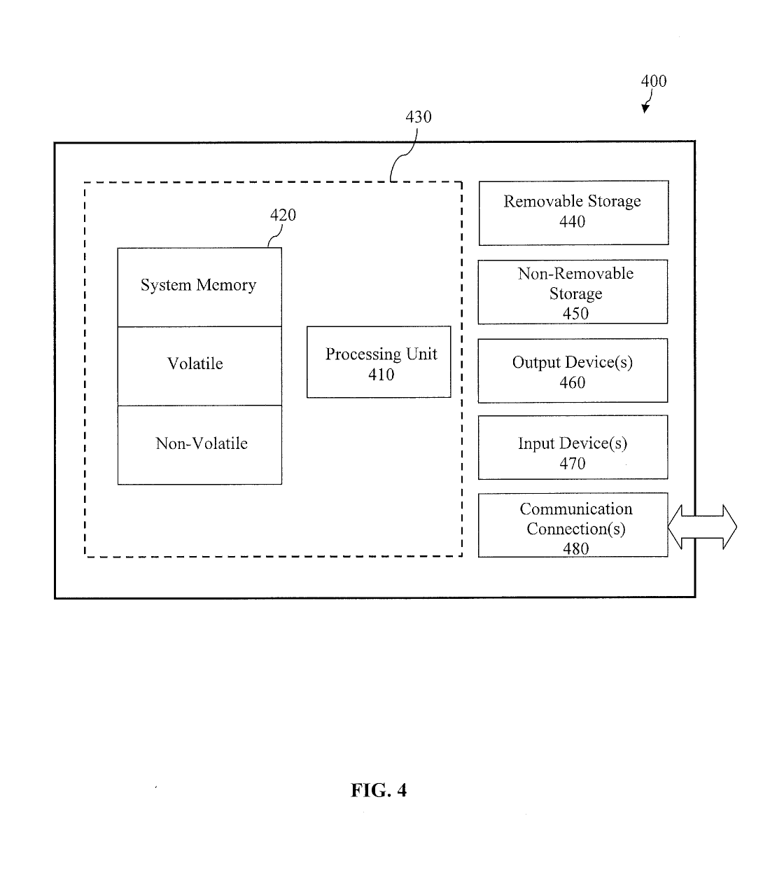

FIG. 4 shows an exemplary computing environment in which example embodiments and aspects may be implemented. The computing device 400 is only one example of a suitable computing environment and is not intended to suggest any limitation as to the scope of use or functionality. As the skilled artisan will appreciate, numerous other general purpose or special purpose computing system environments or configurations may be used. Examples of well known computing systems, environments, and/or configurations that may be suitable for use include, but are not limited to, PCs, server computers, handheld or laptop devices, computer tablets, PDAs, smart phones, multiprocessor systems, microprocessor-based systems, network personal computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computer environments may be used where tasks are performed by remote processing devices that are linked through a communications network or other data transmission medium. In a distributed computing environment, program modules and other data may be located in both local and remote computer storage media including memory storage devices.

With respect to FIG. 4, an exemplary system for implementing aspects described herein includes one or more computing devices, such as computing device 400. In its most basic configuration, computing device 400 typically includes at least one processing unit 410 and memory 420. Depending on the exact configuration and type of computing device, memory 420 may be volatile such as random access memory RAM)), non-volatile such as read-only memory ROM), flash memory, etc.), or some combination of the two. This most basic configuration is illustrated in FIG. 4 by dashed line 430.

Computing device 400 may have additional features/functionality. For example, computing device 400 may include additional storage removable and/or non-removable) including, but not limited to, magnetic or optical disks or tape. Such additional storage is illustrated in FIG. 4 by removable storage 440 and non-removable storage 450. Computing device 400 typically includes a variety of computer readable media. Computer readable media can be any available media that can be accessed by computing device 400 and includes both volatile and non-volatile media and removable and non-removable media. Furthermore, such computer storage media can be implemented in any method or technology for storage of information such as computer readable instructions, data structures, program modules or other data. Memory 420, removable storage 440, and non-removable storage 450 are all examples of computer storage media. Computer storage media include, but are not limited to, RAM, ROM, electrically erasable program read-only memory EEPROM), flash memory or other memory technology; CD-ROM, digital versatile disks DVD), or other optical storage; magnetic cassettes, magnetic tape, magnetic disk storage or other magnetic storage devices; or any other medium which can be used to store the desired information and which can be accessed by computing device 400. Any such computer storage media may be part of computing device 400.

Computing device 400 may contain communications connection s) 480 that allow the device to communicate with other devices. Computing device 400 may also have input device s) 470 such as a keyboard, mouse, pen, voice input device, touch input device, etc. In some embodiments, input device s) 470 may include a voice input device e g, a microphone) operably linked to an internal audio input/output circuit e g, a sound card) configured to digitize audio signals received from the voice input device into data that can be interpreted by the processing unit 410 and/or other components of the computing device 400. In some embodiments, input device s) 470 may include a magnetic card reader for reading magnetically imprinted cards, digital camera, image scanner, or an electronic biometric measuring device such as a fingerprint scanner, retinal scanner, or a vein scanner. Output device s) 460 such as a graphical user interface GUI) or other display capable of displaying graphic images and alphanumeric characters, speakers, a printer, etc. may also be included. All these devices are well known in the art and need not be discussed at length here.

FIG. 1. is an illustration of one exemplary environment 100 in which a requestor may enter a records request to obtain copies of patient health information using the present methods and systems. For example, one or more client devices 110 may communicate with a system server 130 on a computer network 115 or, alternatively, via the Internet 160 on a computer network 125. The one or more client devices 110 may be configured to communicate with the system server 130 to access, receive, retrieve, and display information.

In some implementations, the client device 110 may be implemented using a general purpose computing device such as the computing device 400 described with respect to FIG. 4, for example. The client device 110 may include a desktop PC, workstation, computer tablet, laptop, PDA, kiosk, or any WAP-enabled device or any other computing device capable of interfacing directly or indirectly with the computer network 115 and/or computer network 125. In one embodiment, a client device 110 that is configured to communicate with the system server 130 on the computer network 115 or the computer network 125 is a kiosk or computer tablet. The computer network 115 can be a local area network system or a remote network system that may utilize a hypertext markup language HTML)-based data exchange such as an intranet or extranet. The system server 130 may also be connected to the Internet 160 by the computer network 125. The system server 130 may be configured to support a World Wide Web page set for access by requestors using a client device 110 connected to the Internet 160. Generally, access to the web page supported by the system server 130 is through an Internet Service Provider ISP) that provides an Internet 160 connection for a client device 110 through the computer network 125. In such an embodiment, the client device 110 may also run an instance of a browser application, which may be an hypertext transfer protocol HTTP) client such as MICROSOFT® INTERNET EXPLORER®, MOZILLA FIREFOX®, GOOGLE CHROME®, SAFARI®, or some other browser. The browser may also include a WAP-enabled browser in the case of a cell phone, PDA, or other wireless device, or the like, allowing a requestor using the client device 110 to access, process, and view information and web pages via the Internet 160. In some embodiments, the computer network 125 connects the client device 110 to the system server 130 via direct internet-based transmissions. In other embodiments, the client device 110 is connected to a health care facility's computer system and the requests for personal health care information entered into client device 110 are sent from the health care facility's computer system to the system server 130 over the computer network 125 via the internet 160. Exchange of data accomplished in a secure manner using the computer network 115 or computer network 125 may be via a non-public network, such as a password restricted network, encrypted network, paid network, membership network, or other network not open to the general public. Methods of data encryption and decryption are known in the art.

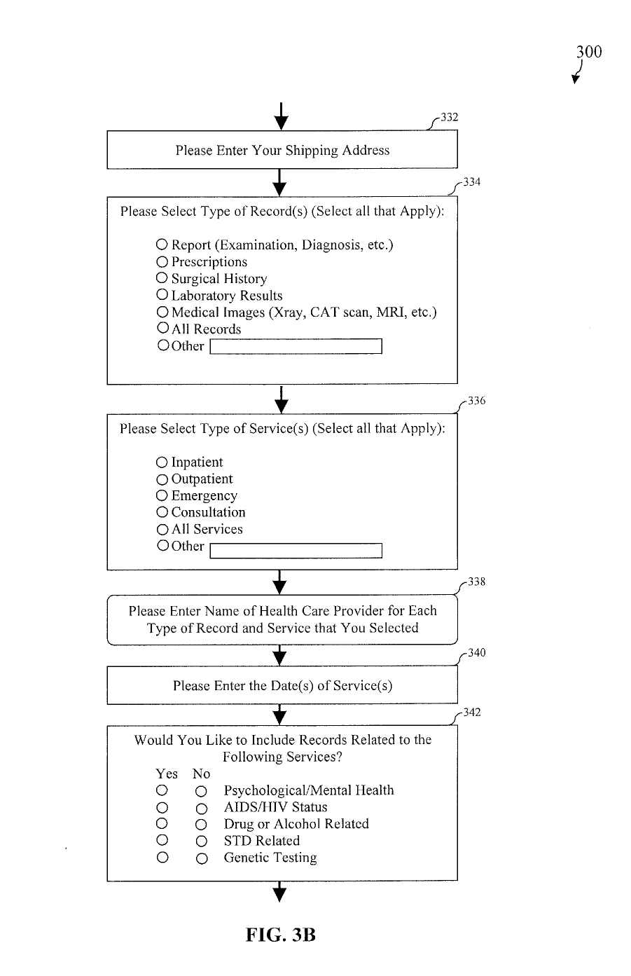

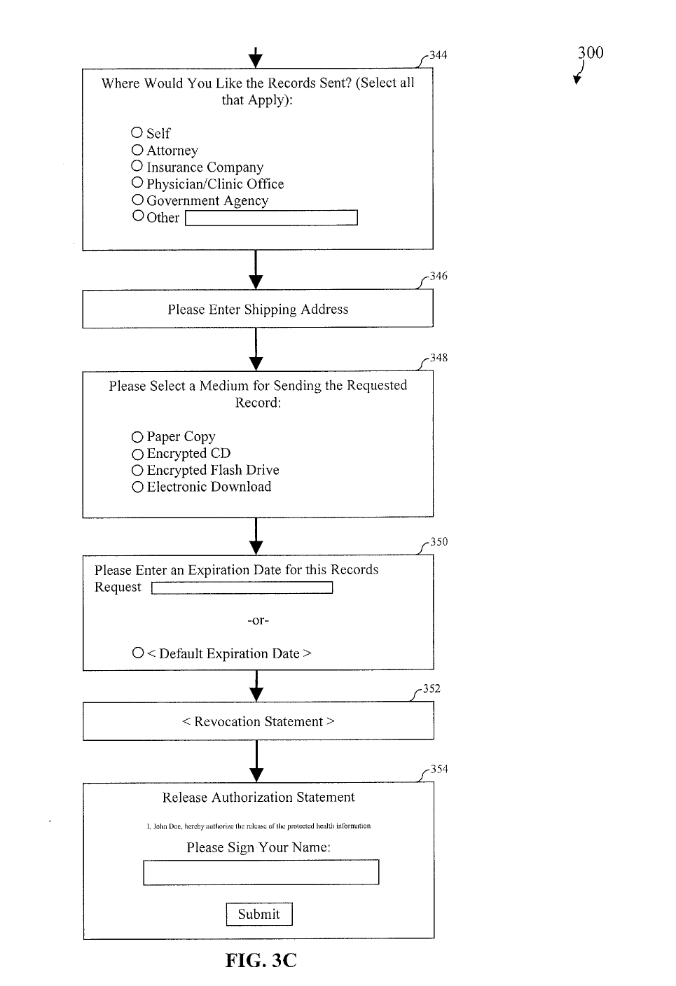

Furthermore, the client device 110 may include a display that is a GUI 120 for viewing and entering information. In a preferred embodiment, the GUI 120 is configured for touch-screen capability for the input of alphanumeric data, more preferably, it is configured to provide instructions for the requestor to enter the records request in successive self-directed screens. For example, a GUI 120 may be configured to provide instructions in successive self-directed screens that prompt the requestor to provide various data elements that are required for the records request. A first screen may prompt the requestor to enter the name of the patient whose records are being requested, a second screen may then prompt the requester to enter his or her name and relationship to the patient, and so on. A non-limiting exemplary embodiment of successive self-directed screens suitable for use in implementing aspects disclosed herein is provided in FIGS. 3A-3C.

In other embodiments, the client device 110 is configured for voice input capability and enables the requestor to enter a records request using voice commands. For example, in such an embodiment, the requestor interfaces with the client device 110 via a voice input device e g, microphone) that communicates with an internal audio input/output circuit, such as a sound card. The audio signals received from the voice input device are converted by the internal audio/output circuit into digital data that is then interpreted by a microprocessor and/or other components of the client device 110. In this embodiment, the client device 110 may further comprise a speech or voice recognizer configured to analyze the digital data corresponding to the voice input and to interpret and determine the words or phrases spoken by the requestor. The speech or voice recognizer then converts the digital data corresponding to the voice input into data elements for the request. The speech or voice recognizers described herein may be implemented in software, hardware, or as combinations of hardware and software and may utilize one or more recognition algorithms. Various speech or voice recognizers are known in the art and need not be discussed at length here. For example, voice or speech recognizers are disclosed in U.S. Pat. No. 5,068,900; U.S. Pat. No. 6,499,015; U.S. Pat. No. 7,698,131; and U.S. Pat. No. 8,024,195 each incorporated herein by reference).

In some embodiments, the client device 110 includes a GUI 120 configured for voice input capability and enables the requestor to enter a records request using voice commands in response to instructions provided to the requestor in a successive self-directed screens. In such an embodiment, the client device 110 may have a GUI 120 that is configured for both voice input capability and touch-screen capability. In still other embodiments, the client device 110 further comprises interactive voice response technology and is configured to provide the requestor audible instructions via an output device, such as the output device 460, that may be one or more speakers. In an embodiment, the client device 110 may comprise interactive voice response technology for providing the requestor with audible instructions in a series of successive self-directed screens and enable the requestor to enter the records request via voice commands as described herein.

In general, the requestor may enter the records request using client device 110, which is then communicated to system server 130 and presented to the system manager 140. The system manager 140 is enabled to access the records request through the system server computer 130 either directly or via an enabled computing device, such as the computing device 400 depicted in FIG. 4, which can be a desktop PC, workstation, laptop, computer tablet, PDA, any WAP-enabled device, or any other computing device in communication with the system server 130. In addition, the system manager 140 is further enabled to access at least one patient database 150 via system server 130. Some implementations include a merchant processor 170 that may communicate with the system server 130 for the purposes of facilitating payment of fees associated with the records request.

FIG. 7 is an illustration of an exemplary central unit or system server 130. The system server 700 may also be a computing device 400. System server 700 provides command and control and collects and delivers data to one or more client devices 110 via the computer network 115 and/or the Internet 160. System server 700 has a CPU 710 that is operably connected to server system bus 715. A memory device 720 capable of storing instructions is operably connected to server system bus 715. An access module 730 capable of transmitting and receiving data or HTML is operably connected to server system bus 715.

The access module 730 provides an interface to enable the system server 700 or 130 to communicate with external computing devices, such as the client devices 110, and one or more external databases, such as a patient database 150, using one or more computer networks. Preferably, at least a portion of the one or more computer networks is a nonpublic computer network or secure network. Furthermore, access module 730 may enable the system manager 140 to access at least one patient database 150 for determining if the requested personal health information exists and obtaining or locating the requested personal health information as discussed above. The patient database may be maintained within the system server 140, preferably it is maintained externally, more preferably the patient database 150 is created and maintained external to the system server by the professional health care provider. While access module 730 may communicate with a patient database 150 on any computer network connection known in the art, preferably the computer network connection will be a secure network connection or a nonpublic network connection as discussed above.

In one embodiment, the requestor uses a client device 110 and enters a records request includes requested personal health information. The client device may be located in the facility of the health care provider or off-site and may communicate with the system server 130 over a nonpublic network 115 or over the Internet 160. Preferably, if using the Internet 160, the requestor enters the records request over network 125 via a secure portal. In certain embodiments, the requested personal health information may include all or a portion of the health care services performed for a particular patient. The types of health care services performed on a particular patient may include inpatient care, outpatient care, emergency services, STD and/or drug testing, psychological evaluation and/or testing, surgery, genetic screening/testing, or any other type of health care services known in the art. In another embodiment, the requested personal health information may include all or a portion of the types of health care records produced from any or all of the health care services performed on the patient, including, but not limited to, examination reports, medication reports, consultation reports, orders, progress notes, prescriptions, diagnoses, prognoses, laboratory results and/or reports, physiological and psychological test results, STD and HIV/AIDS status, blood tests, genetic information such as the presence of mutations associated with increased disease risk), mental health assessment, reports related to other invasive or non-invasive ancillary care services, and technology created/supported medical images such as a digital camera image, MRI, X-ray, CT scan, EKG, PET scan, ultrasound, and the like).

In yet another embodiment, the requested personal health information includes the identity of at least one health care provider that performed the particular health care service requested and/or maintains the type of health care record requested. In yet other embodiments, the requested personal health information includes a date on which the requested health care service was performed on the patient. In a preferred embodiment, the requested personal health care information includes at least one type of health care record, at least one type of health care service performed, and the date on which such health care service was performed.

In another embodiment, the records request includes identifying information for the patient associated with the requested personal health information. In particular, the identifying information is information sufficient to uniquely identify the patient as per industry standards and/or pursuant to legal requirements. In a preferred embodiment, the identifying information associated with the requested personal health information is the patient's name, more preferred, it is the patient's name and at least the last four digits of the patient's social security number, most preferred, it is the patient's name, at least the last four digits of the patient's social security number, and the patient's date of birth.

In some embodiments, the records request includes identifying information for the requestor. In particular, the identifying information is information sufficient to uniquely identify the requestor as per industry standards and/or pursuant to legal requirements. In a preferred embodiment, the identifying information for the requestor also includes information evidencing that such requestor is authorized to obtain the requested personal health information pursuant to legal requirements such as HIPAA and GINA). It is to be understood that the type and amount of information necessary to verify that the requestor is authorized to obtain the requested personal health information may be changed by amendments to the existing law or by newly enacted laws. In some embodiments, the identifying information includes the name of the requestor. In other embodiments, the identifying information includes one or more addresses of the requestor, including, but not limited to, the billing or home address of the requestor, one or more electronic mail Email) addresses, or a shipping address for the requestor. In yet other embodiments, the identifying information includes a relationship to the patient such as spouse, friend, child, sibling, aunt, uncle, legal guardian, adopted child, ward or charge, employer, and the like. In yet other embodiments, the identifying information includes a photographic identification document, such as a government-issued identification card, passport, military identification card, driver's license, and the like. In other embodiments, the identifying information includes documents including, e g, legal documents) evidencing that the requestor is an authorized representative of the patient associated with the requested personal health information such as, e g, a power-of-attorney or a court order). Alternatively, the present methods and systems may include electronic devices configured to scan or otherwise take biometric measurements sufficient for uniquely identifying the requestor, including fingerprint scanning, retinal scanning, vein scanning, and the like.

In a preferred embodiment, the identifying information includes the name of the requestor, more preferred it includes the name of the requestor and either a government issued identification document verifying that the requestor is the patient associated with the requested personal health information or a legal document evidencing that the requestor is an authorized representative of the patient associated with the requested personal health information. Alternatively, the identifying information includes the name of the requestor, a government-issued identification document, and a digital photograph taken of the requestor at the time of the records request.

In another embodiment, the records request includes a designated destination for sending the requested personal health information. In some embodiments, the designated destination is a shipping, mailing, or Email address of the requestor. In other embodiments, the designated destination may be a shipping, mailing, or Email address of a third party other than the requestor, such as the patient if the requestor is not the patient associated with the requested personal health information), an attorney, an insurance company, a health care provider, an employer, a government entity such as a state disability bureau, the Social Security Administration, a branch of the military, or any other government entity or agency), or any other person or entity. In yet other embodiments, the designated destination is a secure web portal or internet website from which the requestor is enabled to download the requested personal health information.

In yet another embodiment, the records request includes a specified delivery medium for sending the requested personal health information to the designated destination. The requested personal health information may be sent as any delivery medium known in the art, including paper, film, binary code, optical disc, floppy disk, magnetic tape, compact disc CD), flash drive, digital video disc DVD), Laserdisc LD), Email, electronic download, facsimile, and the like. In addition, certain delivery media may be encrypted for enhanced security. In a preferred embodiment, the specified delivery medium is paper, CD, DVD, flash drive, or electronic download, more preferably, it is paper, encrypted CD, encrypted DVD, encrypted flash drive, or electronic download. It is to be understood that any requested personal health information that is maintained in a particular storage medium can be converted to another type of medium for delivery. For instance, an X-ray film can be retrieved and converted to a digital image and sent to the designated destination as an encrypted DVD delivery medium using techniques known in the art. Likewise, an electronic consultation report in an electronic storage medium such as portable document format PDF), tagged image file format TIFF), or any other electronic format known in the art) can be printed onto paper and sent to the designated destination in a paper-based delivery medium.

In one embodiment, the records request includes at least one type of requested personal health information. In a preferred embodiment, the records request includes requested personal health information and identifying information for a patient associated with the requested personal health information. In a more preferred embodiment, the records request includes requested personal health information and identifying information for a patient associated with the requested personal health information, identifying information for the requestor, and a destination for sending the requested personal health information, most preferably it includes requested personal health information and identifying information for a patient associated with the requested personal health information, identifying information for the requestor, a destination for sending the requested personal health information, and a specified medium for sending the requested personal health information. Other embodiments include any one or more of the above-discussed combinations as the records request.

In a preferred embodiment, the client device 110 has a display, such as a GUI 120, that presents to the requestor instructions for entering the records request. In some embodiments, the requestor is enabled to enter the records request using a keyboard or similar alphanumeric input device. In other embodiments, the GUI 120 is configured for touch-screen capability and/or voice input capability, more preferably, the GUI 120 has touch screen capability and enables the requestor to enter the records request in a succession of self-selected screens as depicted in FIG. 3. The instructions may prompt the requestor to enter information regarding the patient identity, types of service performed, dates of service, and other information related to personal health information as described above. Once the requestor operating a client device 110 enters the records request, it is presented to the system manager 140 for review.

The system manager 140 may be one or more persons or entities) that manage one or more administrative aspects of the present methods and systems for obtaining health care records. In particular, the system manager 140 is enabled to access or view the records request using the system server 130 directly or by using an enabled computing device such as a desktop PC, workstation, laptop, computer tablet, PDA, any WAP-enabled device, or any other computing device) in communication with the system server 130. In general, the system server 130 is configured to communicate with one or more patient databases 150 from one or more professional health care providers.

In some embodiments, the system manager 140 is located at the professional health care provider's facility and can access one or more patient databases 150 therein through the system server 130. In other embodiments, the system manager 140 is located at a facility off-site from the professional health care provider's facility and can access one or more patient databases 150 in that professional health care facility via the system server 130. In yet other embodiments, the system manager 140 is located at a centralized location off-site from a plurality of professional health care provider facilities and can access one or more patient databases 150 in each of the professional health care facilities through the system server 130. In yet other embodiments, the professional health care provider's patient database 150 is located off-site and can be accessed by the system manager through the system server 130.

Preferably, the system manager 140 can access the personal health information data in the patient database 150 to retrieve the requested personal health information if stored in an electronic medium in the patient database 150 or, if the personal health information is stored as paper or other non-electronic medium, determine the location of the requested personal health information. If the system manager 140 determines that the some or all of the requested personal health information does not exist, then the system manager 140 may immediately notify the requestor that the requested personal health information does not exist. Preferably, the system manager 140 notifies the requestor by sending such a notification over the computer network 115 or computer network 125 that is then displayed to the requestor on the GUI 120 of the client device 110.

The system manager 140 also reviews the identifying documents entered by the requestor to determine whether the requestor is authorized to obtain copies of the requested personal health information. As described in more detail below, the requestor may use an image scanning device or a digital image capture device such as a digital camera) operably connected to the client device 110 in order to send to the system manager 140 a digital image of the identifying documents. For example, in one embodiment, the requestor uses a digital camera or image scanner to scan a government-issued photo identification card to send the image to the system manager 140 for review. In such an embodiment, the requestor may additionally be prompted to take his or her photo with the digital camera to send a digital image of the requestor to the system manager 140 for comparison with the government issued photo identification card. In other embodiments, the requestor can use an image scanner to scan documents evidencing the requestors status as an authorized representative of the patient associated with the requested personal health information. In yet other embodiments, electronic devices capable of biometric analysis can be operably connected to the computing device to send fingerprint scans, retinal scans, vein scans, and other biometric data to the system manager 140 to determine whether the requestor is authorized to obtain or release copies of the requested personal health information. If the system manager 140 determines that the requestor is not authorized to obtain or release copies of the requested health information, the system manager 140 is enabled to immediately notify the requestor that the requestor is not authorized. Preferably, the system manager 140 notifies the requestor by sending such a notification over the computer network 115 or computer network 125 that is then displayed to the requestor on the GUI 120 of the client device 110.

In some implementations, it may be desirable to operably connect to a client device 110 various electronic devices to enable the requestor to evidence his or her identity and/or authorization. In some embodiments, the client device 110 includes an input device, such as input device 470, that is configured to receive data to enable a system manager 140 to determine whether the requestor is authorized to receive or release the requested patient health records. The input device 470 can be an image scanner that utilizes an image sensor to optically scan images, printed text, handwriting, or an object in order to convert it to a digital image that can be sent to the system server 130 for presenting to the system manager 140. Suitable image sensors include charge-coupled device CCD) sensors, a contact image sensors CIS), or a photomultiplier tube PMT) as the image sensor. Alternatively, the image scanner is not included in the client device 110, but is directly or indirectly connected to the device via communication connection 480. For example, the image scanner can be connected to the client device by way of a universal serial bus USB) port or the like.

In a preferred embodiment, the image capture device is a digital camera that utilizes image sensor pixels for optically capturing an image, printed text, object, and the like in order to convert them to a digital image for sending to the system server 130 to present the digital image to the system manager 140. The digital camera may be any digital camera commonly used with computing devices. Suitable digital image sensors include a CCD sensors, complementary metal-oxide semiconductor CMOS) sensors, back-side-illuminated CMOS BSI-CMOS) sensors, and the like.

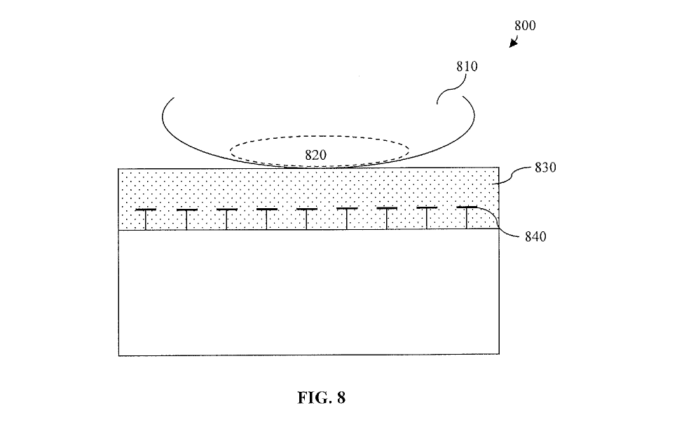

As discussed above, it may be desirable to utilize other methods of identification such as biometric authentication. Any device suitable for uniquely identifying an individual using biometric analysis may be employed. For example, input device 470 may include a retinal scanning device, fingerprint scanning device, or a vein matching device. A retinal scan is a biometric technique that uses the unique patterns on an individual's retinal blood vessels for identification. In some embodiments, the retinal scan is performed by casting an unperceived beam of low-energy infrared light into a person's eye as they look through a retinal scanner eyepiece. The retinal scanner captures the individual's retinal blood vessel pattern and converts it to a digital image. Similarly, vein identification scanners cast a infrared light or a near-infrared light emitting diode LED) light on a person's finger or palm. Since the hemoglobin in the blood absorbs this light, a digital camera such as a monochrome CCD camera) captures the darkened image pattern of the blood vessels and converts it to a digital image. Finally, fingerprint scanning takes advantage of an individual's unique fingerprint pattern and may utilize an image capture device such as a CCD camera, CMOS camera, CCD image scanner, CIS image scanner, PMT image scanner, a or any other image capture device capable of converting optical images of the individual's fingerprints to digital images. Some embodiments of the fingerprint scanning device may include a capacitive sensing device as disclosed in U.S. Pat. No. 6,016,355 incorporated herein by reference) and as depicted in FIG. 8. As shown in FIG. 8, a fingerprint scanning device may be a capacitive sensing-device 800. With a capacitive sensing-device 800, a finger 810 is brought into contact with a sensing surface 830, such as glass, plastic, or other suitable insulating materials. Because the fingerprint surface 820 of a finger is uneven, certain portions will physically contact the sensing surface while other portions will be spaced apart from the sensing surface 830. Each sensing element 840 forms a capacitor with the portion of the finger located directly there above. The sensing elements 840 form one set of electrodes for the capacitors, and the ridges and valleys of the finger form the other set of electrodes for the capacitors. The difference in capacitances are subsequently transformed into a signal representing a topographic image of the fingerprint.

Once the system manager determines that the requested personal health information exists and the requestor is authorized to obtain or release copies of the requested personal health information, the system manager 140 obtains the requested personal health information as discussed above and prepares the requested personal health information for delivery in the specified delivery medium to the designated destination. In some embodiments, the system manager 140 determines the fees associated with the records request. In such an embodiment, the fees may be calculated based on any number of factors as desired by the system manager 140 or other entity operating the system. Once the system manager 140 determines the appropriate fee for a records request, a request of payment can be sent to the requestor by notification such as sending a notification over the computer network 115 or computer network 125 that is then displayed to the requestor on the GUI 120 of client device 110), by Email such as sending an Email over the Internet 160 to client device 110), paper bill, or any other convenient method. The request of payment may include instructions on how the requestor may pay the bill, such as how to pay by credit card or providing an address for sending a paper check. In a preferred embodiment, the requestor may access the system over a network via a secure portal and pay the bill by credit card or other electronic payment.

In some embodiments, payment collection is carried out by a merchant processor 170, which can be the system manager 140 or a third party that specializes in merchant processing, including credit card or debit purchasing, electronic funds transfer or collecting, and/or processing other payment from a requestor. In a preferred embodiment, the merchant processor 170 is a third party specializing in the merchant process and is enabled to communicate with the system server 130 by way of a secure network. Such an interface may be facilitated by the access module 730 or a separate module, such as a payment module 740 operably connected to server system bus 715.

In some embodiments, the client device 110 used by the requestor to enter the records request includes an electronic device such as a magnetic card reader for reading magnetically imprinted cards such as credit or debit cards. In other embodiments, the requestor may enter credit card or debit card information by accessing the system server using the Internet 160 as described above. Once the requestor has satisfied the request for payment, the system server 130 notifies the system manager 140 of such payment. For example, the merchant processor 170 may communicate to the system server 130 that payment has been made via payment module 740 and presented to the system manager 140. At this point, the system manager 140 may send the requested personal health information in the specified delivery format to the designated destination.

In another object, the system manager 140 may send the requested personal health information to the designated destination in the specified delivery medium as described above. In a some embodiments, the system manager 140 sends the requested personal health information only after notification that the requestor has satisfied the request for payment. In certain embodiments, the requestor may select as a designated destination the option to download from a secure portal or internet website of the system. In such an embodiment, the system may be configured to enable the requestor to download the requested personal health information from the secure portal or internet website only after the request for payment is satisfied.

In some embodiments, the system server 130 includes a tracking module 760 that is configured to track and record transaction data elements, including at least one of: 1) the details of the records request entered by the requestor and 2) the actions taken by the system manager 140, including the determination that the requestor was or was not authorized, accessing the requested personal health information from the patient database 150, and whether or not the requested personal health information was sent to the designated destination. In such an embodiment, a system server 130 may contain one or more databases for storing transaction data, such as the transaction database 750 depicted in FIG. 7, which is operably connected to server system bus 715. In some embodiments, the transaction database 750 is maintained external to system server 130, and in other embodiments it is maintained within system server 130.

In other embodiments, the tracking module 760 is a separate system in communication with system server 130 that is configured to track and record transaction data elements from system server 130, including at least one of: 1) the details of the records request entered by the requestor and 2) the actions taken by the system manager 140, including the determination that the requestor was or was not authorized, accessing the requested personal health information from the patient database 150, and whether or not the requested personal health information was sent to the designated destination. In such an embodiment, the tracking module 760 may store the transaction data elements in one or more databases for storing transaction data, such as the transaction database 750 depicted in FIG. 7, which is operably connected to server system 130 and can be maintained external to system server 130 or maintained within system server 130.

In yet other embodiments, the tracking module 760 is a set of computer-executable instructions e g, a software program) configured to operate on the system server 130 for the tracking and recording transaction data elements from system server 130, including at least one of: 1) the details of the records request entered by the requestor and 2) the actions taken by the system manager 140, including the determination that the requestor was or was not authorized, accessing the requested personal health information from the patient database 150, and whether or not the requested personal health information was sent to the designated destination. In a preferred embodiment, the tracking module 760 contains data elements provided in the requests and the processing steps to complete the fulfillment of the records request. In such an embodiment, the tracking module 760 may store the transaction data elements in one or more databases for storing transaction data, such as the transaction database 750 depicted in FIG. 7, which is operably connected to server system 130 and can be maintained external to system server 130 or maintained within system server 130.

In a preferred embodiment, the tracking module 760 is configured to track transaction data elements that include at least one of 1) the records request entered by the requestor; 2) notification to the requestor that the requested personal health information does not exist; 3) notification to the requestor that he or she was not authorized to obtain or release some or all of the copies of the requested personal health information; 4) confirmation that the requestor authorization was verified by the system manager 140; 5) copies of the requested personal health information were prepared by the system manager 140; 6) the type of delivery medium prepared by the system manager 140; 6) amount of fees due in the request for payment; 7) the amount of the request for payment that has been satisfied; 8) completion of the transaction; and 9) any other aspect of the transaction. In such an embodiment, tracking data related to the transaction may be maintained in a transaction database 750, which may be maintained internal or external to the system server 130. In a more preferred embodiment, the tracking module 760 is configured to automatically track transaction data elements related to the records request.

It is another object to enable a requestor to query the status of a records request and/or the transaction related to the records request. In such an embodiment, tracking data from one or more steps as described above is stored in a transaction database 750 and is accessible by the requestor over a secure network. In other embodiments, the requestor is enabled to query the status of a records request and/or the transaction related to the records request by querying the system server 130, which transmits the query data elements to the tracking module 760 preferably the system server automatically transmits the query data elements to the tracking module 760. In such an embodiment, the tracking module 760 then transmits the status information data elements from the transaction database 750 over computer network 115 or 125 via system server 130, which is then displayed to the requestor via client device 110, preferably the tracking module automatically transmits the status information data elements. In another embodiment, the tracking module 760 instructs the system server 130 to transmit the status information data elements from the transaction database 750 over a computer network 115 or 125, which is then displayed to the requestor via client device 110, preferably the tracking module automatically instructs the system server 130 to transmit the status information data elements. In a preferred embodiment, the tracking module 760 is “meaningful use” certified for privacy and security by the Drummond Group 2014) and its report capability provides certified accounting of health record disclosures. In a preferred embodiment, the tracking system of tracking module 760 is only accessible by the system manager 140.

In certain embodiments, the requestor may send a records request by mail or over the phone. In such an embodiment, the system manager 140 may enter the data elements related to the request into tracking module 760 manually via system server 130. The data elements related to the request transaction are then stored in the transaction database 750.

In a preferred embodiment, the requestor may query the system server 130 to see the status of the records request at any time. The query may include the details of the records request entered into the system by the requestor, whether the requestor was authorized to obtain the requested personal health information, whether the requested personal health information was sent to the designated destination, whether payment has been made, or any other aspect of the transaction. In preferred embodiments, the requestor is enabled to query the status of the records request transaction at any time after the initial records request is entered into the system using client device 110. In some embodiments, the requestor may query the status of the records request transaction for so long as the data related to the records request transaction is maintained in a database, such as the transaction database 750. In some embodiments, the data related to the records request transaction is maintained in the transaction database for a period of 1, 2, 3, 4, 5, 6, 7, 8, 9, 10 days or more following the completion of the transaction. In other embodiments, the data related to the records request transaction is maintained in the transaction database for a period of 10, 20, 30, 40, 50, 60, 70, 80, 90, 100 days or more following the completion of the transaction. In yet other embodiments, the data related to the records request transaction is maintained in the transaction database for a period of 1 to 365 days or more following the completion of the transaction. In yet other embodiments, it is maintained for a period of 1 to 10 years or more following the completion of the transaction.

In certain implementations, it may be desirable to provide an expiration date for the records request after which time the records request, if not completed, will no longer be honored. Therefore, one embodiment of the present methods and systems may include providing instructions to the requestor via the GUI 120 of the client device 110 that prompts the requestor to select an expiration date after which time the records request, if not completed, will no longer be honored by the system manager 140. In other embodiments, the requestor is provided with a pre-determined expiration date. Alternatively, the requestor is provided with a pre-determined expiration date but may enter an alternate expiration date if so desired. The expiration date may be any date from the date the records request is submitted until a date ranging anywhere from 24 hours to 10 years or more after the submission of the records request. In some embodiments, the expiration date is 1, 10, 20, 30, 40, 50, 60, 70, 80, 90, 100 days or more after the submission of the records request. In other embodiments, the expiration date is 1, 2, 3, 4, 5, 6, 7, 8, 9, 10, 11, 12 months or more after the submission of the records request. In yet other embodiments, the expiration date is 1, 2, 3, 4, 5, 6, 7, 8, 9, 10 years or more after the submission of the records request. In a preferred embodiment, the expiration date is six months after the submission of the records request. In a more preferred embodiment, the expiration date is one year after the submission of the records request.

In some implementations, the requestor is required to read a release authorization statement and sign that statement before any requested personal health information can be obtained or released. For example, once the requestor enters the records request using client device 110, he or she may be prompted to read a release authorization statement, the contents of which are sufficient to meet applicable legal requirements for the release of personal health information, including PHI. The requestor may then be instructed to sign the release statement indicating he or she has understood the contents of the release authorization statement and agrees to authorize the release of the requested personal health information. In some embodiments, the client device 110 includes an electronic signature pad operably connected to the client device 110 such as an input device 470. In a preferred embodiment, the client device 110 has a GUI 120 with touch-screen capability thereby enabling the requestor to sign the GUI 120 using a stylus or other applicable object commonly used in the art.

In some embodiments, the requestor is presented with a revocation statement informing the requestor how to revoke the records request if desired. For example, the revocation statement may be displayed to the requestor on the GUI 120 of the client device 110.

The databases provided herein can be structured in any manner, and can be maintained or stored on any computer readable medium. The databases can be maintained or stored and/or accessed via a network, or can be maintained or stored and/or accessed locally. All financial data, personal health care information, and other personal data can be maintained according to a pre-determined standard of data security and in accordance with all applicable legal requirements related to financial and health-related data, or for personal data. Preferably, a high standard of data security is selected.

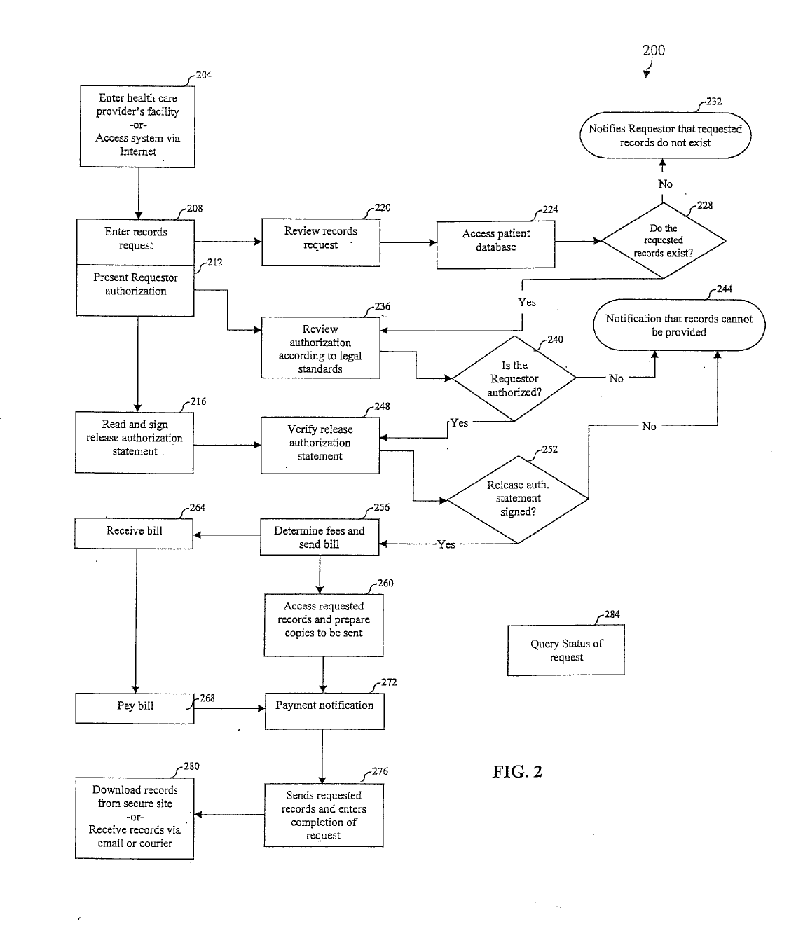

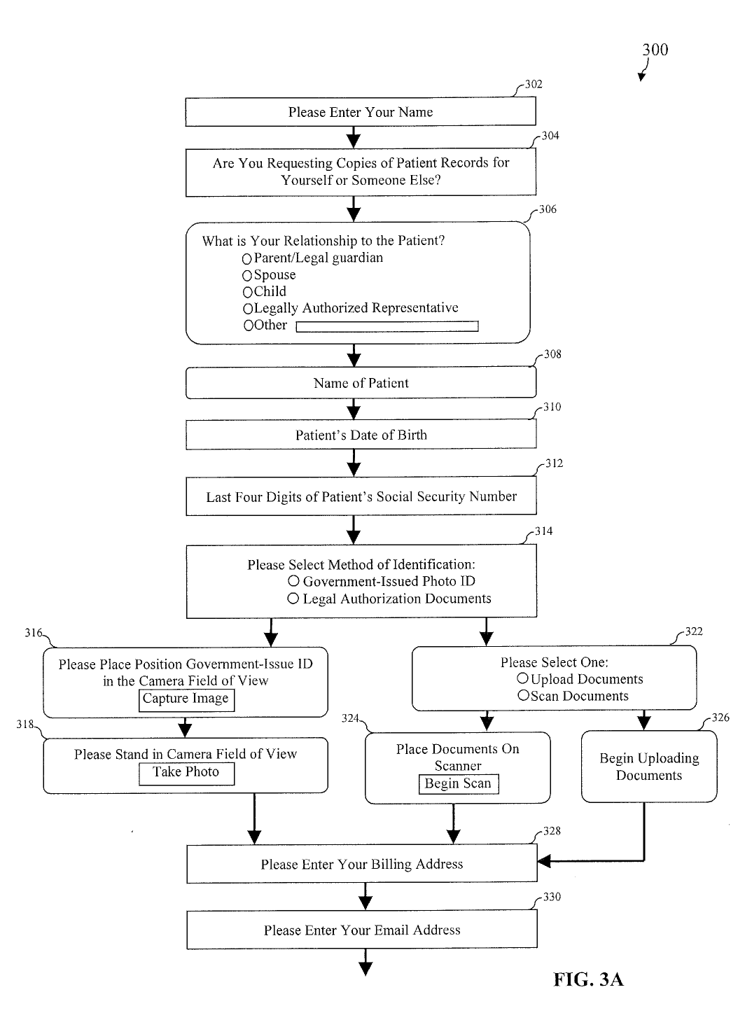

To better describe the capabilities of the present methods and systems, FIG. 2 depicts an exemplary embodiment of the present process in a detailed flowchart. In addition, FIGS. 3A-C depicts an exemplary embodiment of a GUI 120 configured to present to the requestor instructions for entering the records request in a succession of self-directed screens.

As shown in FIG. 2, a requestor may begin the process by entering the health care provider's facility 204, where he or she may be directed to client device 110, such as a kiosk, or handed a client device 110, such as a computer tablet, to begin entering the records request. The requestor may also use a client device 110, such as a PC, laptop, PDA, or other WAP-enabled device, to log onto the system website via the Internet 160 and begin entering the records request. The requestor may then be prompted to enter his or her name 302 and to designate whether he or she is entering the records request for himself or herself or for on behalf of a third party 304. If the requestor indicates that he or she is requesting records for a third party, the next screen may then prompt the requestor to indicate his or her relationship to the patient associated with the records request. For example, the screen 306 may provide the requestor with a series of pre-selected responses, such as parent, legal guardian, spouse, child, authorized representative, and the like, as well as a free text entry space to enable the requestor to enter a response that is not pre-selected. Alternatively, the requestor may be presented with a series of pre-selected responses that include a response indicating that the requestor is the patient associated with the records request e g: the pre-selected responses include “self” as an option) thereby combining the previous two steps into a single step. The requestor may then be prompted to enter the name of the patient 308, the patient's date of birth 310, the last four digits of the patient's social security number 312, or any other patient identifying information.

The requestor is then prompted to present documentation evidencing that the requestor is authorized to obtain or release the requested personal health information 212. For example, the display screen 314 may enable the requestor to choose from a series of pre-selected responses to indicate the type of indentifying documentation that the requestor will use to establish authorization, such as a government-issued photo identification or other legal authorization documents as discussed above. In certain implementations, the requestor may click on or touch the screen to indicate that he or she wishes to present a government-issued photo identification. As shown in FIG. 3A, the requestor may then be instructed to position his or her government-issued photo identification within a camera field of view 316 or on a designated part of the display screen and initiate image capture e g: clicking or touching “Capture Image”). In some embodiments, the requestor may be instructed to stand in the camera field of view 318 in order to have a picture taken by a digital camera operably connected to the client device 110. In other embodiments, the requestor may indicate that he or she is an authorized representative of the patient and wishes to present legal authorization documents, such as a power of attorney or a court order. In this case, the requestor is instructed to either upload or scan the necessary documents 322 324 326 into the client device 110 using an image scanner or other image capture device. The requestor may then be prompted to enter additional identifying information such as the requestor's billing address 328, the requestors Email address 330, and the requestor's shipping address 332.

As shown in FIG. 3B, the requestor may then be presented with a series of screens enabling the requestor to indicate the type of records he or she wishes to obtain or release 334, the type of services that were performed 336, the name of the health care provider 338 that performed the service s), and the dates on which the health care services were performed 340. The system may display to the requestor a series of pre-selected responses for types of records, such as reports, prescriptions, surgical history, laboratory results, medical images, all records, and the like, and/or types of services, such as inpatient, outpatient, emergency, consultation, all services, and the like. In addition, the system may also display to the requestor a free text entry space to enable the requestor to enter a response that is not pre-selected.

In some embodiments, such as those where the requestor is using a client device 110 in the lobby or other area of the health care provider's facility, there may be no need to indicate the name of the health care provider. In such an embodiment, the requestor would not be prompted to indicate the name of the health care provider.

In some cases, the requestor may not wish to obtain or release certain types of personal health information that are particularly sensitive, such as, e g, genetic testing results, HIV status, and mental health. Therefore, as shown in FIG. 3B, some embodiments may include a screen that presents to the requestor the ability to specifically include or exclude certain types of personal health information 342. The system may display to the requestor a series of pre-selected responses, such as records relating to psychological health, mental health, AIDS/HIV status, drugs or alcohol, STD status/results, genetic testing results, and the like, to enable the requestor to specifically exclude copies of certain types of personal health information from being obtained or released. In addition, the system may also display to the requestor a free text entry space to enable the requestor to enter a response that is not pre-selected.

According to FIG. 3C, the system may display to the requestor instructions for designating a destination for the records to be sent. For example, the requestor may be prompted to indicate where the records are to be sent such as to himself or herself, an attorney, an insurance company, another health care provider, a government agency, or other designated destination) 344, provide the appropriate shipping address 346, and/or specify one or more media such as paper, encrypted CD or DVD, encrypted flash drive, or electronic download) for sending the requested records 348.

FIG. 3C depicts additional instruction screens providing the requestor with an opportunity to select a default expiration date or designate an alternative expiration date 350, a revocation statement informing the requestor how to revoke the request 352, if desired, and a release authorization statement 356.

As the skilled artisan will appreciate, the particular order of the instructions demonstrated by FIGS. 3A-C is one possible configuration of the process and is not intended to be limiting in any way. The present methods and systems may be implemented to present the instructions in the same order as shown in FIGS. 3A-C or a different order and may include all of the instructions shown in FIGS. 3A-C or a portion of the instructions. In addition, the present methods and systems may be implemented to include instructions not shown in FIGS. 3A-C or varied from those shown in FIGS. 3A-C. In some embodiments, a client device 110 enables the requestor to enter the data elements in response to the instructions manually via a keyboard or other alphanumeric input device. In other embodiments, the client device 110 is configured for touch-screen capability and/or voice input capability. In some embodiments, the instructions are presented to the requestor visually via the GUI 120 of the client device 110. In other embodiments, the instructions are presented to the requestor audibly over one or more speakers of the client device 110.

Once the requestor reads and signs the release form 216, the records request is submitted for review. The system manager then reviews the records request 220 and accesses the appropriate patient database to determine if the requested personal health information exists 228. If so, the system manager may review the authorization documents submitted by the requestor 236 to determine whether the requestor is authorized e g, legally authorized) to obtain or release copies of the requested personal health information 240. If the system manager determines that all or a portion of the requested personal health information does not exist or cannot be retrieved, then the system manager may notify the requestor of the same 232. In addition, if the system manager determines that the requestor is not authorized to obtain or release copies of the requested personal health information or if the submitted documentation was unclear or insufficient evidence of authorization, the system manager may then notify the requestor that the all or a portion of the requested personal health information cannot be provided 244. At this point, the requestor may be provided with another opportunity to provide explanation or produce additional documentation to establish authorization. Alternatively, the foregoing steps may be performed at the same time or in reverse order, i e the system manager may determine if the requestor is authorized prior to or at the same time that the system manager determines whether some or all of the requested personal health information exists or is retrievable.

As shown in FIG. 2, if the system manager determines that the requested personal health information exists and that the requestor is authorized to obtain or release the requested personal health information, the system manager will then verify that the release authorization statement has been properly signed by the requestor 248 and 252. If the release authorization statement was not signed or has not been properly signed, then the system manager notifies the requestor that the requested records cannot be provided 244. At this point, the requestor may or may not be given another opportunity to correct this deficiency. In some implementations, the records request cannot be submitted without the signature block being signed by the requestor. Even in such a case, the system manager may still be required to match the signature with the government-issued identification or verify that the signature matches the name of the requestor provided in the records request. In other implementations, the records request cannot be submitted by the requestor without a signed release authorization statement and there may be no need for the system manager to verify that the release authorization statement has been signed.

According to FIG. 2, once the system manager has determined that the requested records exist, the requestor is authorized to obtain or release copies of the requested records, and the requestor has signed the release authorization statement, the system manager then determines the number of copies of the requested records, calculates the fees due, and then send a request for payment of fees to the requestor 256. The system manager may send the request for payment of fees by Email, or, if no Email was provided by the requester, by any commercially recognized courier e g: U.S. mail) to the billing address provided by the requestor. The request for payment may include instructions on how the requestor may pay by credit card, where to mail a paper check, or other payment options. Once the requestor receives the request for payment 264, the requestor must satisfy the request for payment in order to initiate release of the requested personal health information. Once the bill is paid, the system manager is automatically notified of the payment 272 and may send the requested personal health information to the designated destination and enter into the system that the transaction has been completed.

The requested health information is then sent to the designated destination by courier or Email or prepared for download from a secure site 280 as discussed above. In alternative embodiment, the requestor may satisfy payment at the time of request by using a client device 110 that enables the requestor to enter payment information, such as a credit card number or bank account, at the time the request is submitted or, alternatively, the client device 110 may include a magnetic card reader for reading magnetically imprinted cards e g: credit/debit cards). In yet other implementations, the requestor may use a client device 110 to satisfy payment via any mobile payment system known in the art, such as, e g, APPLE PAY or GOOGLE WALLET.

In some implementations, some or all of the above steps are tracked and recorded by the tracking module 760 and stored in a transaction database 150. Thus, according to FIG. 2, the requestor may query the system server 130 for the status of the records request at any point from initiation of the records request through completion of the records request 284, preferably the requestor may query the status of the records request for so long as the data related to the records request transaction is maintained in the transaction database. In some embodiments, the data related to the records request transaction is maintained in the transaction database for a period of 1, 2, 3, 4, 5, 6, 7, 8, 9, 10 days or more following the completion of the transaction. In other embodiments, the data related to the records request transaction is maintained in the transaction database for a period of 10, 20, 30, 40, 50, 60, 70, 80, 90, 100 days or more following the completion of the transaction. In yet other embodiments, the data related to the records request transaction is maintained in the transaction database for a period of 1 to 365 days or more following the completion of the transaction. In yet other embodiments, the data related to the records request transaction is maintained in the transaction database for a period of 1 to 10 years or more following the completion of the transaction.

It is to be understood that the particular order of the steps demonstrated by FIG. 2 is not intended to be limiting in any way. The present methods and systems may be implemented to present the steps in the same order as shown in FIG. 2 or a different order and may include all of the steps shown in FIG. 2 or some of the steps shown in FIG. 2. In addition, the present methods and systems may be implemented to include additional steps not shown in FIG. 2 or steps that vary slightly or significantly from those shown in FIG. 2.

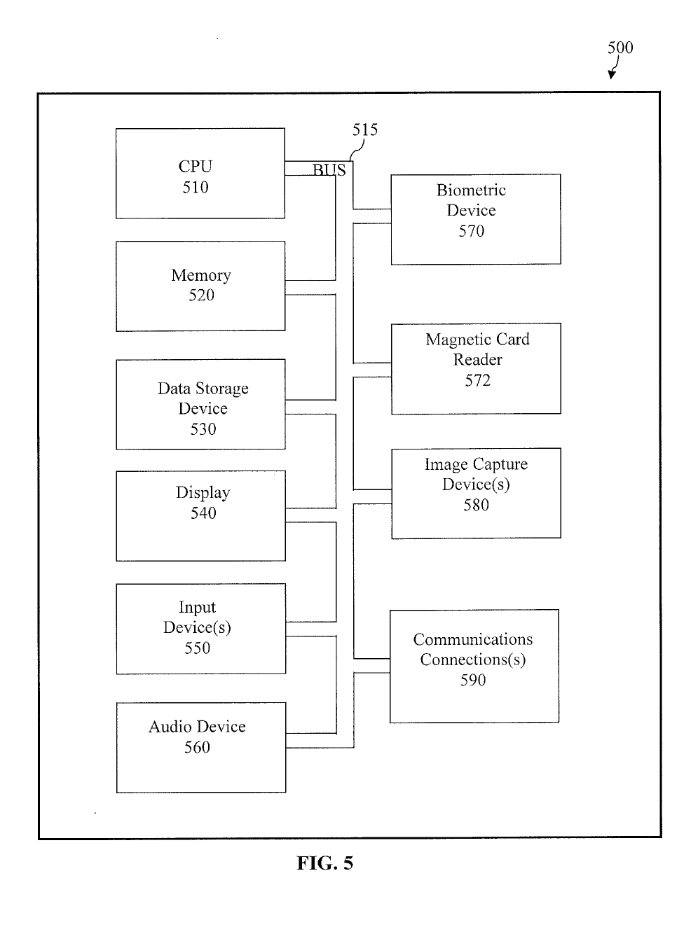

As noted above, in a preferred embodiment, the client device 110 is a computer tablet or a kiosk. FIG. 5 illustrates an exemplary kiosk 500 that may be suitable for use as a client device 110. The kiosk 500 may implement a computer device similar to computing device 400. Further, kiosk 500 includes a central processing unit CPU) 510 operably connected to a system bus 515. System bus 515 may be a single bus or a series of buses for communicating data or signals between various devices and CPU 510. In addition, a memory device 520 for storing instructions is operably connected to system bus 515. A data storage device 530 for storing data, or containing databases and/or other instructions, is operably connected to system bus 515. The kiosk 500 also may include one or more communications connection s) 590 for communicating data or signals between devices external to kiosk 500 operably connected to system bus 515. Kiosk 500 additionally includes a display device 540 for displaying information to the requestor, which is operably connected to system bus 515. In some embodiments, at least one input device 550 can be utilized. An input device 550 is operably connected to system bus 515 and may include a keyboard with alphanumeric and function keys for communicating information and command selection to the CPU 510. Additionally, input device 550 may include a cursor control device to input cursor movement of a given direction or manner of displacement. Such a cursor control device may include a trackball, mouse, joystick or may be directed and/or activated via input from the keyboard using special keys and sequence commands. In yet other embodiments, input device 550 may include a voice input device, such as a microphone. In a preferred embodiment, the display device 540 is a GUI with alphanumeric input or touch-screen capability. In a more preferred embodiment, the display device 540 is a GUI with touch screen capability and enables the requestor to enter the records request via a succession of self-directed screens.

In some embodiments, the kiosk 500 includes an optional audio device 560 for providing the kiosk with sound capability, which may be operably connected to system bus 515. Other embodiments of the kiosk 500 may include a biometric device 570, such as a retinal scanner, fingerprint scanner, or vein scanner, for measuring biometric data to uniquely identify the requestor. Such a biometric device 570 may be operably connected to system bus 515. In yet other embodiments, the kiosk 500 includes a magnetic card reader 572 for reading magnetically imprinted cards e g: credit/debit cards) operably connected to system bus 515. In a preferred embodiment, the kiosk 500 includes an image capture device 580, more preferably the image capture device 580 is a digital camera for optically capturing images and converting them to digital images.

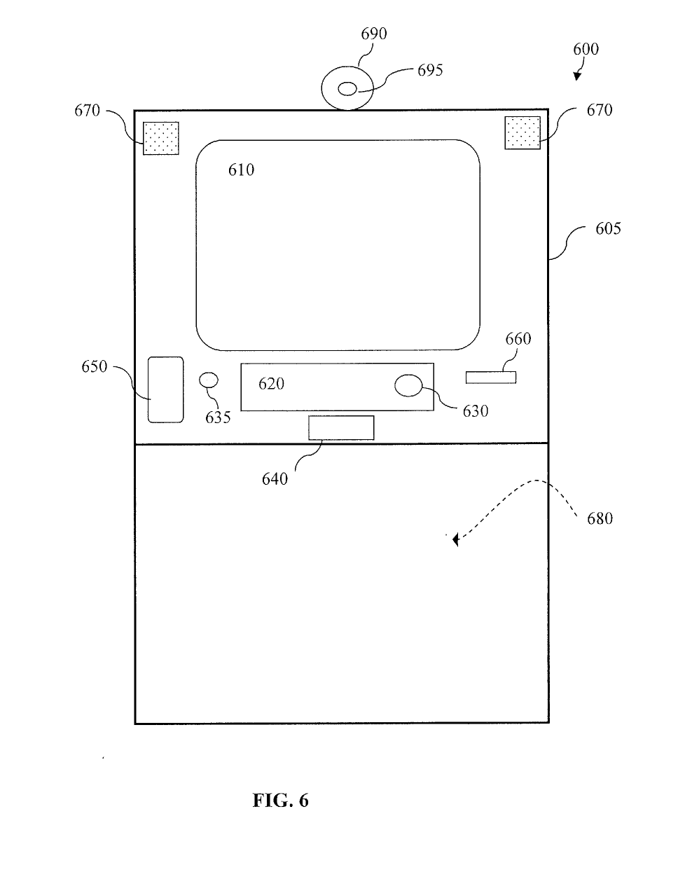

FIG. 6 depicts a front view of the kiosk 500 of FIG. 5. The kiosk 600 includes a housing 605 that forms an enclosure. A computer 680 is included inside housing 605. The computer 680 may be the computer of 430 or one or more components illustrated in FIG. 5, such as CPU 510. A display 610 is positioned on the front of housing 605. Preferably, display 610 is a GUI with touch screen capability. Alternatively, an alphanumeric keypad 620 with a cursor control device 630 may be positioned on the front of housing 605. Some embodiments of kiosk 600 may include both a display 610 that is a GUI with touch screen capability and an alphanumeric keypad 620 with or without a cursor control device 630. In other embodiments, kiosk 600 may include a microphone 635 or other audio/voice input device. In a preferred embodiment, kiosk 600 includes a digital camera 695 that may be positioned on the front of housing 605. In some implementations, the digital camera 695 may be encased in an adjustable housing 690. In some embodiments, an electronic signature pad 640 is positioned on the front of housing 605. In other embodiments, an electronic device configured for taking biometric measurements such as a fingerprint scanner, retinal scanner, or a vein scanner) 650 is positioned on the front of housing 605. In yet other embodiments, a magnetic card reader 660 for reading magnetically imprinted cards is positioned on the front of housing 605. Optionally, stereo speakers 670 may be positioned on the front of housing 605. One skilled in the art will understand that the inclusion and/or arrangement of the particular components included in kiosk 600 may vary.

In the specification, there have been disclosed typical preferred embodiments. Although specific terms are employed, they are used in a generic and descriptive sense only and not for purposes of limitation. The scope is set forth in the claims. Many modifications and variations are possible in light of the above teachings. It is therefore understood that within the scope of the appended claims, the present methods and systems may be practiced otherwise than as specifically described.

What is claimed:

1. A method performed by a computing device that includes a memory and one or more processors to obtain personal health information comprising:
a) receiving a records request from a client device over a network, wherein said client device is operated by a requestor, and wherein said records request comprises:
i) requested personal health information;
ii) identifying information for a patient associated with said requested personal health information;
iii) identifying information for the requestor; and
iv) a designated destination for sending said requested personal health information;
b) presenting said records request to a system manager, wherein said system manager is enabled to:
i) determine whether said requestor is authorized to obtain said requested personal health information;
ii) access a first database comprising a plurality of patient data, wherein each of said patient data is associated with a storage medium comprising personal health information for a patient, and wherein said personal health information comprises said requested personal health information; and
iii) send said requested personal health information to said designated destination; and
c) creating a second database comprising a plurality of tracking data related to steps a) and b).

2. The method of claim 1, wherein said records request further comprises a specified delivery medium for sending said requested personal health information to said designated destination, and wherein said system manager is further enabled to send said requested personal health information as said specified delivery medium.

3. The method of claim 1, further comprising after step b) and before step c) the further steps of:
b) 1) sending to the requestor a payment requirement sufficient to pay for services and fees associated with said records request; and
b) 2) notifying said system manager when said payment requirement has been paid; and
wherein said second database further comprises a plurality of tracking data related to steps b) 1) and b) 2).

4. The method of claim 3, wherein said payment requirement is collected by a merchant processor.

5. The method of claim 1, wherein said client device comprises a personal computer, workstation, laptop, computer tablet, personal digital assistant, kiosk, or wireless application protocol-enabled device.

6. The method of claim 1, wherein said client device comprises a graphical user interface for displaying to the requestor a succession of self-directed screens configured to enable said requestor to enter said records request.

7. The method of claim 1, wherein said storage medium is electronic.

8. The method of claim 1, wherein said client device further comprises:
a) a magnetic card reader configured to read magnetically imprinted cards;
b) a digital image capture device comprising an image sensor having a plurality of sensor pixels for capturing a digital image and presenting said digital image to the system manager;
c) an electronic device configured to collect a plurality of biometric data from said requestor; or
d) any combination of a)-c);

9. The method of claim 1, wherein the requestor is enabled to query said tracking data of said records request.

10. The method of claim 1, wherein each of said personal health information, second database and network is maintained with at least industry standards and legal requirements for financial data and health records.

11. A system comprising a processor and a memory for obtaining personal health information comprising:
a) a client device configured to send a records request over a network, wherein said records request comprises:
i) requested personal health information;
ii) identifying information for a patient associated with said requested personal health information;
iii) identifying information for a requestor operating said client device; and
iv) a designated destination for sending said requested personal health information;
b) an central unit configured to receive said records request and to provide to a system manager access to said records request, wherein said system manager is further enabled to:
i) determine whether said requestor is authorized to obtain said requested personal health information;
ii) access a patient database comprising a plurality of patient data, wherein each of said patient data is associated with a storage medium comprising personal health information for a patient, and wherein said personal health information comprises said requested personal health information;
iii) send said requested personal health information to said designated destination; and
c) a transaction database;
wherein said central unit is further configured to track and record actions of a) and b) for storage in said transaction database.

12. The system of claim 11, wherein said records request further comprises a specified delivery medium for sending said requested personal health information to said designated destination, and wherein said system manager is further enabled to send said requested personal health information as said specified delivery medium.

13. The system of claim 11, wherein said system manager is further enabled to notify said requestor of a payment requirement sufficient to pay for services and fees associated with said records request, and wherein said central unit tracks and records said notification of a payment requirement for storage in said transaction database.

14. The system of claim 13, further comprising a payment module for automatically notifying the system manager when said payment requirement has been paid.

15. The system of claim 11, wherein said client device comprises a personal computer, workstation, laptop, computer tablet, personal digital assistant, kiosk, or wireless application protocol-enabled device.

16. The system of claim 11, wherein said client device comprises a graphical user interface for displaying to the requestor a succession of self-directed screens to enable the requestor to enter said records request.

17. The system of claim 11, wherein said client device further comprises:
a) a magnetic card reader configured to read magnetically imprinted cards;
b) a digital image capture device comprising an image sensor having a plurality of sensor pixels for capturing a digital image and presenting said digital image to the system manager;
c) an electronic device configured to collect a plurality of biometric data from said requestor; or
d) any combination of a)-c).

18. The system of claim 11, further comprising a merchant processor capable of payment collection.

19. The system of claim 11, wherein said requestor is enabled to access said transaction database.

20. The system of claim 11, wherein each of said personal health information, network, central unit, and transaction database is maintained with at least industry standards and legal requirements for financial data and health records.
